(19) United States
(12) Patent Application Publication
(10) Pub. No.: US 2025/0322757 A1
(43) Pub. Date: Oct. 16, 2025

(54) SYSTEMS AND METHODS FOR MANAGING TURNAROUND OF AIRCRAFT AT AN AIRPORT

(71) Applicant: THE BOEING COMPANY, Arlington, VA (US)

(72) Inventors: Anna Meringer, Sopot (PL); Michael Eric Irrgang, Black Diamond, WA (US); Jacek Bankowski, Gdansk (PL); Pawel Giczewski, Gdansk (PL)

(73) Assignee: THE BOEING COMPANY, Arlington, VA (US)

(21) Appl. No.: 18/632,530

(22) Filed: Apr. 11, 2024

(51) Int. Cl. G08G 5/00; B64D 43/00

(52) U.S. Cl. CPC G08G 5/30; B64D 43/00; G08G 5/21

(57) ABSTRACT

A system and a method include a control unit configured to provide a plurality of turnaround task lists. Each of the plurality of turnaround task lists differs from one another. An aircraft is configured to be operated during a turnaround at an airport according to a selected one of the plurality of turnaround task lists.

### FIELD OF THE DISCLOSURE

Examples of the present disclosure generally relate to systems and methods for managing a turnaround of an aircraft at an airport.

### BACKGROUND OF THE DISCLOSURE

Aircraft are used to transport passengers and cargo between various locations. Numerous aircraft depart from and arrive at a typical airport every day.

An aircraft flies according to a defined schedule. A typical schedule indicates that an aircraft is to arrive at an airport at a particular time, and at a particular gate. The schedule further indicates that the aircraft is to depart from the airport at a later time. The time between the arrival at the airport and the subsequent departure is referred to as turnaround. During the turnaround, numerous tasks are performed. For example, the aircraft arrives at the gate. The aircraft is then hooked up to a jet bridge, ground support equipment, and/or the like. Next, arriving passengers disembark the aircraft. The internal cabin is then cleaned. The aircraft is refueled. Departing passengers board the internal aircraft. Such are examples of tasks that occur during a turnaround.

Turnarounds are scheduled for each planned flight in advance. To efficiently plan turnarounds, airlines and ground operation providers use turnaround templates. Turnaround templates are lists of tasks (such as unloading, cleaning, boarding, and the like) that are to be performed to complete a turnaround. Each of the tasks have defined beginning and end times in relation to an arrival time and departure time.

Typically, each airline has a small number of defined turnaround templates and definitions. Assignment of templates to particular turnarounds is based on simple rules and is done manually by airline or ground operation personnel. As can be appreciated, such process makes a planning process rigid. Further, it can be difficult to update templates when external factors change. In such situations, too many different turnaround types may have to be combined, sometimes inappropriately, or else the operation becomes unwieldy.

Because of the aforementioned complexity, templates are typically only updated every five years. As can be appreciated, the process of planning turnarounds, and utilizing pen and paper to manage such turnarounds is time and labor intensive.

### SUMMARY OF THE DISCLOSURE

A need exists for an improved system and method for planning a turnaround of an aircraft at an airport. Further, a need exists for an effective and efficient system and method for managing turnaround.

With those needs in mind, certain examples of the present disclosure provide a system including a control unit configured to provide a plurality of turnaround task lists. Each of the plurality of turnaround task lists differs from one another. An aircraft is configured to be operated during a turnaround at an airport according to a selected one of the plurality of turnaround task lists.

As an example, each of the plurality of turnaround task lists differs from one another in relation to one or more tasks, times for the tasks, a sequence of tasks, and/or a number of tasks. In at least one example, the plurality of task lists include predefined generic templates, which can be modified by an administrator.

In at least one example, the control unit is further configured to receive data from one or more flight information sources. In at least one example, the control unit is further configured to automatically determine the plurality of turnaround task lists based on the data received from the one or more flight information sources. In at least one example, the control unit is further configured to automatically match sets of turnaround features to turnaround task lists, and decide on priorities for assignments. In at least one example, the control unit is further configured to automatically select the selected one of the plurality of turnaround task lists based on the data received from the one or more flight information sources. Moreover, in at least one example, the control unit automatically determines a number of resources (such as workers, robots, supply vehicle, and/or the like) needed for a given turnaround.

In at least one example, the control unit is further configured to automatically match one of the plurality of turnaround task lists with a set of turnaround features.

In at least one example, the control unit can be further configured to automatically select the selected one of the plurality of turnaround task lists based on data received from one or more flight information sources.

The one or more flight information sources include a tracking sub-system configured to track the aircraft and other aircraft on ground and in an airspace, a weather sub-system, aviation data sources configured to provide information regarding aviation flight operations, aircraft data sources configured to provide information about various aircraft, airport data sources configured to provide information regarding one or more airports, flight schedule data sources configured to provide information regarding flight schedules, and/or assignments data sources configured to provide information regarding assigned gates, aircraft, personnel, fuel trucks, supply vehicles, and/or the like.

In at least one example, the control unit is further configured to monitor, during the turnaround, tasks of the selected one of the plurality of turnaround task lists. As a further example, the control unit is further configured to update the selected one of the plurality of turnaround task lists in response to a change in one or more aspects of the tasks during the turnaround.

In at least one example, the system also includes one or more user interfaces in communication with the control unit. The one or more user interfaces include a display. The control unit is further configured to show the selected one of the plurality of turnaround task lists on the display.

The control unit can be further configured to automatically operate one or more devices to automatically perform one or more tasks within the selected one of the plurality of turnaround task lists.

One or more controls of the aircraft can be configured to be automatically operated to perform one or more tasks within the selected one of the plurality of turnaround task lists.

The control unit can be an artificial intelligence or machine learning system.

Certain examples of the present disclosure provide a method including providing, by a control unit, a plurality of turnaround task lists, wherein each of the plurality of turnaround task lists differs from one another in relation to one or more tasks, times for the tasks, a sequence of tasks, or a number of tasks.

Certain examples of the present disclosure provide a method including providing, by a control unit, one or more matches of sets of turnaround features to turnaround task lists, wherein each of the sets of turnaround features differs from one other another in relation to one or more features thereof.

### BRIEF DESCRIPTION OF THE DRAWINGS

FIG. 1 illustrates a block diagram of a system, according to an example of the present disclosure.

FIG. 2 illustrates a front view of a display showing a turnaround task list, according to an example of the present disclosure.

FIG. 3 illustrates a flow chart of a method, according to an example of the present disclosure.

FIG. 4 illustrates a schematic block diagram of a control unit, according to an example of the present disclosure.

FIG. 5 illustrates a perspective front view of an aircraft, according to an example of the present disclosure.

FIG. 6 illustrates a flow chart of a method, according to an example of the present disclosure.

FIG. 7 illustrates a flow chart of a method, according to an example of the present disclosure.

FIG. 8 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide a system and a method that include a control unit configured to provide a turnaround task list, which includes a set of activities (such as unloading, cleaning, boarding, and the like) required during a turnaround of an aircraft at an airport. In at least one non-limiting example, a turnaround task list is or otherwise includes a list of tasks for a turnaround of an aircraft at an airport. A template is an example of a turnaround task list having added information regarding the various tasks. As an example, a turnaround task list provides a template for each task when start times are added, events are defined and/or timed, and if timed, end times added and termination windows indicated. Further, the template can include defined data sources. The data sources can include button clicks, computer data, clock, video, and/or the like. The template can also include contingencies, such as which include actions that are contingent on other actions. The aforementioned are examples of information provided within a turnaround task list that provides a template.

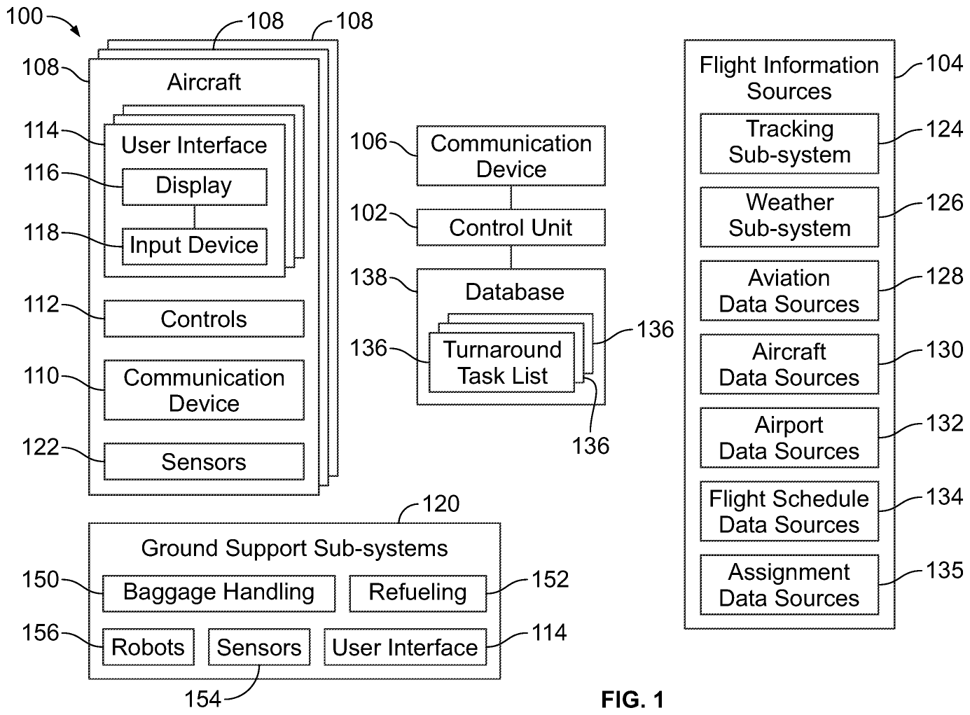

FIG. 1 illustrates a block diagram of a system 100, according to an example of the present disclosure. The system 100 includes a control unit 102 in communication with a plurality of flight information sources 104, such as through one or more wired or wireless connections. For example, the control unit 102 can be coupled to a communication device 106 that receives data from the flight information sources 104. The communication device 106 can be one or more of an antenna, a transceiver, an internet connection, a cloud-based connection, and/or the like.

The control unit 102 is also in communication with one or more aircraft 108, such as via communication between the communication device 106 and a communication device 110 of the aircraft 108. The communication device 110 can be an antenna, a transceiver, an internet connection, a cloud-based connection, and/or the like. In at least one example, the control unit 102 is separate and distinct from the aircraft 108. For example, the control unit 102 can be located at a central monitoring location, which can be remote from, or optionally co-located with, one or more of the flight information sources 104. As another example, the control unit 102 can be onboard the aircraft 108, such as within a flight deck or cockpit. For example, the control unit 102 can be part of a flight computer of the aircraft 108.

The aircraft 108 includes controls 112 configured to allow an operator, such as a pilot, to control operation of the aircraft 108. For example, the controls 112 include one or more of a control handle, yoke, joystick, control surface controls, accelerators, decelerators, and/or the like.

The aircraft 108 also includes one or more user interfaces 114. For example, a user interface 114 can be within a flight deck or cockpit of the aircraft 108. As another example, a user interface 114 can be within an internal cabin of the aircraft 108, such as within a galley, or held by a flight attendant. In at least one example, a user interface 114 includes a display 116 and an input device 118. In at least one example, the display 116 is an electronic device configured to electronically show images, videos, text, and/or the like. For example, the display 116 is configured to electronically show a turnaround task list 136, as described herein. The display 116 can be a monitor, screen, television, touchscreen, and/or the like. The input device 118 can include a keyboard, mouse, stylus, touchscreen interface (that is, the input device 118 can be integral with the display 116), and/or the like. The user interface 114 can be, or part of, a computer workstation. For example, the user interface 114 can be part of the flight computer within the flight deck or cockpit of the aircraft 108. As another example, the user interface 114 can be a handheld device, such as a smart phone, tablet, or the like.

In at least one example, the control unit 102 can be in communication with a user interface 114 that is not onboard an aircraft 108, in addition to (or optionally instead of) the user interface 114 onboard one or more aircraft 108. For example, the user interface 114 can be at a land-based monitoring location, such as with respect to air traffic control, a flight dispatcher, an airline operations center, and/or the like. As another example, a user interface 114 can be part of a ground support system 120. In at least one example, a user interface 114 can be held by a ground support crew member.

The aircraft 108 also includes sensors 122 configured to detect various aspects of the aircraft 108. As an example, a sensor 122 can be a fuel sensor configured to detect a fuel level of the aircraft 108. As another example, a sensor 122 can be a camera configured to detect a presence of individuals within the internal cabin of the aircraft 108. As another example, a sensor 122 can be a weight sensor configured to detect a weight of various components of the aircraft 108. As another example, a sensor 122 can be a thermometer on or within the aircraft 108.

The control unit 102 receives data (for example, aviation data) from the flight information sources 104. The data includes vast amounts of information from numerous different flight information sources 104. The flight information sources 104 include a tracking sub-system 124, which is configured to track the various aircraft 108 on the ground and in an airspace. In at least one example, the tracking sub-system 124 is configured to track positions of the aircraft 108 in real time. In at least one example, the tracking sub-system 124 is a radar sub-system. As another example, the tracking sub-system is an automatic dependent surveillance-broadcast (ADS-B) tracking sub-system. Real time positions of the aircraft 108 on the ground and within an airspace are detected by the tracking sub-system 124 that receives position signals output by a position sensor of the aircraft 108. For example, the tracking sub-system 124 receives ADS-B signals output by the position sensors of the aircraft 108. As another example, the position sensor of the aircraft 108 can be global positioning system sensors. The position sensor outputs signals indicative of one or more of the position, altitude, heading, acceleration, velocity, and/or the like of the aircraft 108. The signals are received by the tracking sub-system 124.

The flight information sources 104 also include a weather sub-system 126, which provides past, current, and predicted weather for locations of the aircraft 108, airports, and the like. As an example, the weather sub-system 126 can include a weather station, channel, or the like. As another example, the weather sub-system 126 can include aeronautical weather services that provide weather notifications at various locations, such as airports. An example of data from a weather sub-system 126 includes a meteorological aerodrome report (METAR).

The flight information sources 104 also include aviation data sources 128, which provide information regarding aviation flight operations. Examples of the aviation data sources 128 includes NOTAMs, aircraft communication addressing and reporting system (ACARS), Digital Automatic Terminal Information Service (D-ATIS), Pilot Reports (PIREPs), and the like.

In at least one example, the aviation data sources 128 includes a flight route for an aircraft 108. The flight route includes information regarding a flight for an aircraft from a departure airport to an arrival airport, including a path therebetween, altitudes at various flight phases, airspeeds at various phases, and the like.

The flight information sources 104 also include aircraft data sources 130, which provide information about various aircraft. For example, the aircraft data sources 130 include information regarding a type and capabilities of the aircraft 108. The aircraft data sources 130 can be information provided by a manufacturer, maintenance provider, operator, cargo capacity, fuel capacity, number of seats, and/or the like of the aircraft 108.

In at least one example, the aircraft data sources 130 can provide tail-specific information regarding the aircraft 108. The tail-specific information for the aircraft 108 provides information regarding the performance of the specific, actual aircraft, in contrast to a different test aircraft, a general performance model, or the like. Optionally, the aircraft data sources 130 can provide general information regarding the type of aircraft 108.

The flight information sources 104 also include airport data sources 132, which provide information regarding an airport, such as a departure airport and/or an arrival airport for the aircraft 108. The airport data sources 132 can include airport map data, including locations of runways, taxiways, gates, and the like.

In at least one example, the flight information sources 104 also include assignment data sources 135, which includes assignment information regarding a gate, pilot(s), ground operation team(s), aircraft, fuel truck, supply vehicles, and the like for turnarounds.

In at least one example, the flight information sources 104 also include weight and balance data sources, which provide information regarding passengers, baggage, fuel and/or the like. For example, weight and balance data sources can include a number of passengers, amount of cargo, amount of luggage, amount of fuel before fueling, desired amount of fuel after fueling and/or the like.

The flight information sources 104 also include flight schedule data sources 134, which provide information regarding a flight schedule for the aircraft 108. For example, the flight schedule data sources 134 include scheduled departure times and scheduled arrival times for the aircraft 108 at one or more airports. The flight schedule data sources 134 can also include actual arrival times and departure times for previous flights.

FIG. 1 shows examples of flight information sources 104. It is to be understood that various additional and/or other information sources can be used to provide data to the control unit 102, which can analyze the data to provide and/or select a turnaround task list 136.

In operation, the control unit 102 is configured to provide turnaround task lists 136. In at least one example, the turnaround task lists 136 are stored in a database 138 in communication with the control unit 102, such as through one or more wired or wireless connections. Each turnaround task list 136 differs from one another in relation to one or more tasks, times for the tasks, a number of tasks, and/or the like.

As described herein, the system 100 includes the control unit 102, which is configured to provide a plurality of turnaround task lists 136. An aircraft 108 is operated during a turnaround according to a selected one of the plurality of turnaround task lists 136. In at least one example, the control unit 102 is further configured to receive data from one or more flight information sources 104. As a further example, the control unit 102 is further configured to match sets of features of turnaround (such as origin, destination, aircraft type, flight type, time of day, and/or the like) to turnaround task lists, such as before full data (such as weather, air traffic, and the like) is available. As a further example, the control unit 102 is further configured to automatically (for example, without human intervention) determine the plurality of turnaround task lists 136 based on the data received from the flight information source(s) 104. As a further example, the control unit 102 is further configured to automatically (for example, without human intervention) select the selected one of the plurality of turnaround task lists 136 based on the data received from the flight information source(s) 104. As a further example, the control unit 102 is configured to automatically extract specific features of a turnaround from data within the flight information sources 104, and then automatically adjust a selected turnaround task list to the extracted features. In at least one example, the control unit 102 is further configured to monitor tasks of the selected one of the plurality of turnaround task lists 136. As a further example, the control unit 102 is further configured to update the selected one of the plurality of turnaround task lists 136 in response to a change in one or more aspects of the tasks during the turnaround of the aircraft 108 at an airport.

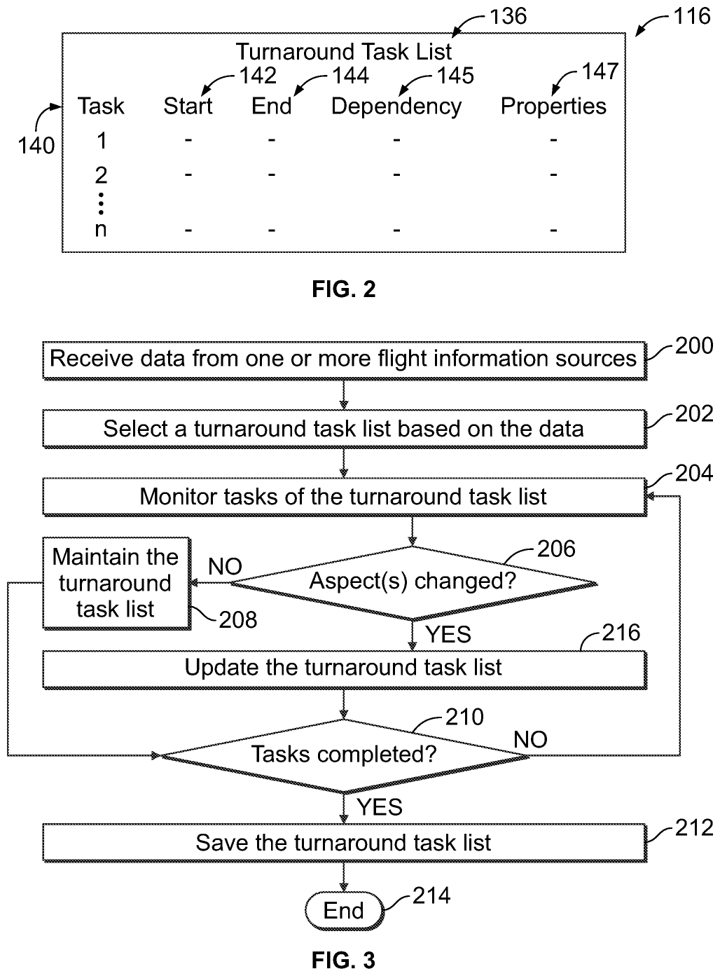

FIG. 2 illustrates a front view of a display 116 showing a turnaround task list 136, according to an example of the present disclosure. Referring to FIGS. 1 and 2, the control unit 102 can show the turnaround task list 136 on the display 116 of any user interface 114. It is to be understood that the turnaround task list 136 shown in FIG. 2 is merely a simplified example.

The turnaround task list 136 includes a list of various tasks 140 that are to be completed during a turnaround of the aircraft 108 at an airport. Examples of the tasks 140 include arrival at gate, coupling to a jet bridge, passengers disembark, internal cabin cleaning, removal of waste, passengers board, catering, refueling of aircraft, and the like. Each task 140 can include a start time 142 and an end time 144. Each task 140 can have contingencies or dependencies 145 (for example, a beginning and/or completion may depend on another task), and properties 147.

The database 138 stores numerous turnaround task lists 136. Each turnaround task list differs from one another with respect to one or more of a number of tasks, a type of task, a sequence of tasks, a start time of a task, an end time of a task, and/or the like. In at least one example, individual operators can construct a turnaround task list 136, such as by entering and selecting information in relation to a task list template. In at least one other example, the control unit 102 automatically determines a turnaround task list 136, such as based on flight information data received from one or more flight information sources 104.

In at least one example, the database 138 stores matches between sets of turnaround features and turnaround task lists 136. Each match differs from one another with respect to one or more of values and/or features. In at least one example, individual operators can create a match, such as by entering and selecting values of features and a list of turnaround tasks. In at least one other example, the control unit 102 automatically determines a match, such as based on flight information data received from one or more flight information sources 104

In at least one example, each turnaround task list 136 is determined from flight information data. As an example, a turnaround task list 136 can be determined based on tracked air traffic in relation to an airport. For example, time frames for tasks can be reduced or increased based on tracked air traffic. As another example, a turnaround task list 136 can be determined based on weather as determined by the weather sub-system 126. For example, time frames for tasks can be reduced or increased based on particular weather conditions. As another example, a turnaround task list 136 can be determined based on the type of aircraft 108, or the tail-specific aspects of the aircraft 108, as received from the aircraft data sources 130. For example, a Boeing 737 can require different tasks than a Boeing 747. As another example, a turnaround task list 136 can be determined based on airport specific data, as received from the airport data sources 132. As another example, a turnaround task list 136 can be determined based on a schedule of an aircraft 108, as received from the flight schedule data sources 134. In at least one example, a turnaround task list 136 can be determined based on one or more types of flight information sources 104, such as tracked data from the tracking sub-system 124, weather data from the weather sub-system 126, aviation data from the aviation data sources 128, aircraft data from the aircraft data sources 130, airport data from the airport data sources 132, flight schedules from the flight schedule data sources 134, and/or the like.

In at least one example, each match is determined from flight information data. As an example, a match can be determined based on historical data regarding duration and delays of turnarounds and tasks at different times of day. As an example, a match can be determined based on historical data about duration of turnarounds and tasks for different sizes of aircraft. For example, turnarounds can be longer for larger aircraft. As another example, international flights can be matched to a different task list than domestic flights.

In at least one example, the control unit 102 automatically determines an optimal number of resources needed to perform a turnaround. Such resources can be robots, vehicles such as baggage trains or fuel truck, machines such as loading machines, and/or human resources. In at least one example the control unit 102 can adjust the list of turnaround tasks if there is a shortage in resources, or there are extra resources available.

In operation, the numerous turnaround task lists 136 are determined and stored in the database 138. For example, an aircraft operator can construct a turnaround task list 136. As another example, the control unit 102 can automatically determine a turnaround task list 136 based on data, such as received from one or more the flight information sources 104. In at least one example, the turnaround task lists 136 includes one or more turnaround task lists 136 constructed by one or more operators, and one or more turnaround task lists 136 automatically determined by the control unit 102.

In at least one example, having the plurality of lists of tasks, the control unit 102 automatically creates a match between each list to a group of turnaround features such as time of day, aircraft model or type of destination, and/or the like. The assignment can be optimized by machine learning or artificial intelligence algorithms taking into account historical data from one or more of the flight information sources 104. Such assignment can happen in advance, long before details of particular turnarounds (for example, weather or numbers of passengers) are known. In at least one example, the control unit 102 prioritizes the matches and defines which list should be chosen if criteria from several groups are met. In at least one example, the control unit 102 shows the matches on the display 116 of the user interface(s) 114. The matches be manually modified by a user, such as a pilot or a ground operation personnel.

Before the aircraft 108 arrives at an airport, a turnaround task list 136 is selected for the aircraft 108. In at least one example, the control unit 102 automatically selects a turnaround task list 136 for the aircraft 108 based on data received from one or more of the flight information sources 104. As an example, the control unit 102 automatically selects a turnaround task list 136 based on data that conforms to parameters of one or more turnaround task lists 136 (and matches) stored in the database 138. For example, each turnaround task list 136 includes parameters related to on one or more types of flight information sources 104, such as tracked data from the tracking sub-system 124, weather data from the weather sub-system 126, aviation data from the aviation data sources 128, aircraft data from the aircraft data sources 130, airport data from the airport data sources 132, flight schedules from the flight schedule data sources 134, and/or the like. The control unit 102 automatically selects a particular turnaround task list that matches one or more of such data.

As an example, if there are many conforming task lists and matches, the control unit 102 uses a matching score to automatically select an optimal list. The matching score can be, for example, the highest percentage match. In another example, the matching score can be a priority calculated with data from one or more of the flight information sources 104. In another example, the matching score can be a priority set via a user interface 114. In at least one example, the control unit 102 selects the particular turnaround task list 136 based on the highest matching score.

In at least one example, before the aircraft 108 arrives at an airport, resources needed for the turnaround are assigned to the turnaround. In at least one example, the control unit 102 automatically selects an optimal number of resources needed based on data received from one or more of the flight information sources 104, such as data regarding available resources within the assignment data sources 135. In at least one example, if the number of available resources changes, the control unit 102 automatically adjusts the resources and the turnaround task list to optimize performance.

The turnaround task list 136 is then shown on a display 116 of one or more user interfaces 114. The status of each task is shown on the display 116. Each task can be monitored by one or more of the sensors 122, which can automatically output status signals for tasks to the control unit 102, which can then show the real time status on the display 116. As another example, individuals can input information regarding a start time and end time for a task via a user interface 114.

In at least one example, the control unit 102 monitors the status of each task from data received by the sensors 122 and/or the user interfaces 114. The control unit 102 further compares the status with the indicated start time and end time for each task of the turnaround task list 136. If an actual start time and/or actual end time for a task (as detected by the sensors 122, and/or monitored by an individual and input via a user interface) differs from the start time and/or end time of the turnaround task list 136, the control unit 102 can then update the start time and/or the end time, and save the change(s) for the turnaround task list 136. In this manner, in at least one example, the control unit 102 monitors actual performance of each task of a turnaround task list 136, and then automatically updates aspects of the task based on any difference between the actual task, and the original aspects as shown in the original task list. In at least one example, the control unit 102 can update such aspects immediately, or based on averages over time.

As shown, the ground support sub-systems 120 are configured to perform various tasks of the turnaround task list. The ground support sub-systems 120 include baggage handling 150 and refueling 152, for example. The ground support sub-systems 120 can also include sensors 154 (such as cameras, weight scales, and/or the like) configured to monitor various aspects of the ground support operations. In at least one example, the ground support sub-systems 120 include individuals who operate cleaning, baggage handling, refueling, and/or the like. Such individuals can enter data, via user interfaces 114, regarding start times and end times of particular tasks. In at least one example, the ground support sub-systems 120 include automated devices, such as robots 156 configured to automatically operate baggage handling, refueling, and/or the like. In at least one example, the control unit 102 is configured to direct automatic operation of one or more tasks of the turnaround task list 136, such as via the robots 156. In at least one example, the control unit 102 is configured to automatically operate one or more devices, such as the robots 56, to automatically perform one or more tasks of the turnaround task list 136. Optionally, the system 100 may not include robots. Also, optionally, the control unit 102 may not automatically perform one or more tasks.

In at least one example, the aircraft 108 is operated according to a turnaround task list 136. For example, one or more components of the aircraft 108 can be automatically operated based on one or more tasks within the turnaround task list 136. Certain controls 112 can be automatically operated, such as by one more control units, to perform (and/or optionally during) one or more of the tasks. For example, the controls 112 of the aircraft 108 can be automatically operated to taxi to the gate during arrival, back away from the gate during a departure, and/or the like. Optionally, the aircraft 108 may not be automatically operated to perform one or more of the tasks.

FIG. 3 illustrates a flow chart of a method, according to an example of the present disclosure. Referring to FIGS. 1-3, at 200, the control unit 102 receives data from one or more of the flight information sources 104. At 202, the control unit 102 selects a turnaround task list 136 from the plurality of turnaround task lists 136 based on the data received from the flight information sources 104. For example, the control unit 102 compares one or more parameters of the data with one or more parameters of the turnaround task lists 136 to determine a matching score (for example, highest percentage match, priority calculated with data from one or more of the flight information sources 104, priority assigned via a user interface 114, and/or the like). The control unit 102 selects the particular turnaround task list 136 based on the highest matching score.

After the turnaround task list 136 is selected, at 204 the control unit 102 monitors tasks of the turnaround task list 136, such as through data received from sensors 122, 154, and/or from user interfaces 114. At 206, the control unit 102 determines if aspects of the tasks (such as start time(s), end time(s), or the like) have changed from those listed in the turnaround task list 136. If not, the control unit 102 maintains the turnaround task list at 208, and the method proceeds to 210, at which the control unit 102 determines if all tasks of the turnaround task list 136 are completed. If not, the method returns to 204. If the tasks are completed at 210, the method proceeds to 212, at which the control unit 102 saves the turnaround task list 136 in the database 138, and the process then ends at 214.

If, however, one or more aspects change at 206, at 216 the control unit 102 updates the turnaround task list 136 to reflect the change(s). The method then proceeds to 210. Optionally, the control unit 102 may not update the turnaround task list 136 based on changed aspects.

In at least one example, the control unit 102 is configured to allow for the turnaround task lists 136 to be generated by an individual, and/or automatically generated, such as by the control unit 102. Various parameters and dependencies can be specified for the tasks within a turnaround task list 136. Data about each task list is processed, structured, and a plurality of customized turnaround task lists 136 can be stored within the database 138. The matches described above, as well as matches regarding particular queries and tasks, can also be stored in the database 138.

In at least one example, the control unit 102 is configured to provide matches. In operation, matches between groups of turnarounds (distinguished by features such as origin, destination, aircraft type, locations within an airport, and/or the like) and task lists are specified. Such can occur during a planning process, such as before a flight arrives, weather is known, and/or the like. In at least one example, a user can manually specify the matches. In at least one example, a user can manually specify particular parameters, and the control unit 102 can automatically match such selections with a turnaround task list 136. In at least one example, the control unit 102 automatically creates matches. Such matches, as well as assignments regarding particular queries and tasks, can also be stored in the database 138.

Each turnaround task list 136 can be determined based on data from the flight information sources 104. Examples of the data include aircraft type, time of day, airport, gate at the airport, origin, destination, domestic or international flight, fleet type, length of flight, and/or the like.

In at least one example, control unit 102 can schedule a turnaround and its task list 136 based on data from the flight information sources 104. Examples of the data include aircraft type, time of day, airport, gate at the airport, origin, destination, domestic or international flight, fleet type, length of flight, and/or the like. The data can be passed to the control unit 102 via wired or wireless connection from any connected system or via a user interface. The control unit 102 extracts turnaround parameters such as aircraft type, type of connection, time or localization on the airport etc. from the provided data to further use them to find an appropriate task list. Next, the control unit 102 can adjust the task list to the provided arrival and departure times, and return a detailed schedule for the given turnaround back to the connected system or to a user via a user interface.

In at least one example, the control unit 102 is an artificial intelligence or machine learning system configured to monitor the tasks, and update various aspects of the tasks on a turnaround task list. In at least one example, the control unit 102 is configured to automatically create a match between turnaround features, and a task list based on at least a portion of received data, such as from one or more of the flight information sources 104 before all flight data is known. In at least one example, the control unit 102 is configured to automatically select an optimal turnaround task list 136 for an aircraft 108 based on data received, such as from one or more of the flight information sources 104. In at least one example, the control unit 102 uses the most up-to-date data for fast changing data such as data about weather or congestion. In another example, if some portion of data is not available, the control unit 102 can still automatically select an optimal turnaround task list 136 for an aircraft 108 based on the deficient data received by supplementing the data with predictions and estimations, such as determined from artificial intelligence.

In at least one example, the control unit 102 shows a list of a plurality of turnaround task lists 136 (such as all of the turnaround task lists 136 stored in the database 138) on a display 116 of a user interface 114. An individual, such as an airline control center officer can filter and sort a turnaround task list 136. The individual can then select a desired turnaround task list 136 from the list. In at least one example, the individual can construct a turnaround task list 136, and save such in the database 138. The individual can also copy a turnaround task list 136. The individual can also modify various aspects of a turnaround task list 136. The individual can also delete a turnaround task list 136. The individual can also manually select a set of turnaround features to create a match to be stored in a database. The individual can also manually assign priorities to existing and/or newly created matches.

In at least one example, an individual can construct a turnaround task list 136 (such as manually via a user interface) by first naming the turnaround task list 136, providing a description thereof, and a notification time for the turnaround task list (for example, number of minutes before a turnaround when a ramp supervisor is provided the turnaround task list on a user interface 114). The individual can list arrival tasks, departure tasks, and total turnaround duration. Additionally, dependencies can be specified in relation to tasks. That is, certain tasks depend on others, and such dependencies can be entered into the turnaround task list 136. Additionally, information regarding the identity of individuals who can modify aspects of the turnaround task list 136 can be included. For example, a flight attendant can be designated as an individual who can modify a task regarding cleaning of an internal cabin.

Additionally, information regarding each of the tasks (such as task type, data source, start, end, duration, and other parameters) can be included. Task parameters can be added, removed, and adjusted in the settings by a user with administration rights. For example, an administrator can add a parameter by adding a name of a parameter, and specifying if the parameter is a string, choice from a list, a number or a yes/no option, and/or the like.

In at least one example, an individual can select support by the control unit 102 to assist in constructing the turnaround task list 136. In such case, machine learning and artificial intelligence algorithms automatically select optimal values for each of the parameters of a task list, such a notification time, arrival tasks, departure tasks, total turnaround duration, dependencies in relation to tasks, information regarding each of the tasks (such as task type, data source, start, end, duration, and other parameters). If artificial intelligence support is chosen, the control unit 102 can suggest one or more sets of tasks with optimally-specified parameters. The individual can accept or modify a proposed parameter. The control unit 102 can also provide an option for showing underlying statistics, and reasoning behind the suggested parameters. The control unit 102 can further provide an investigation option, such as via an icon on a display, which allows for viewing plots, tables, and/or the like. In at least one example, the control unit 102 can automatically (without human intervention) create a turnaround task list with optimally selected parameters.

In at least one example, an individual can match a turnaround task list 136 to a set of turnaround features manually with the use of the user interface. To do so, the individual can provide set of features and a value or set of values for each feature. One feature can be for example “departure flight type” with values “international” and “domestic.” Another feature example is hour of day with values 0, 1, 2, . . . 23. Another feature example can be aircraft type with values 737, 787, A320, etc. For each set of features with chosen values, the individual can assign a turnaround task list. Additionally, the individual can decide on priority of using each set (for example, which turnaround list to choose if a given turnaround conforms multiple feature sets).

In at least one example, an individual can select support by the control unit 102 artificial intelligence systems to assist in constructing the match between turnaround features and a turnaround task list. In such case, machine learning and/or artificial intelligence algorithms automatically select an optimal set of features and optimal values of features together with the matching turnaround task list. In at least one example, the algorithms can also automatically set up priority of the matches. If artificial intelligence support is chosen, the control unit 102 can suggest one or more new matches and/or modifications of the existing matches. The individual can accept, reject, or modify the suggestions. The control unit 102 can also provide an option for showing underlying statistics, and reasoning behind the suggestions. The control unit 102 can further provide an investigation option, such as via an icon on a display, which allows for viewing plots, tables, and/or the like.

In at least one example, the control unit 102 creates matches between sets of turnaround features and turnaround task lists automatically without any input from human individuals.

In at least one example, a list of matches can be displayed on a display of a user interface. A user can sort, filter, create, delete and modify the matches in the list. In at least one example, control unit 102 can automatically create a match with a generic turnaround task list for turnarounds not specified by any of the group in existing matches. In at least one example, for each match, a user can specify a priority number that defines which turnaround task list should be assigned if a given turnaround conforms with two sets (higher number prioritizes assignment). In at least one example, a match with a generic turnaround task list has a lowest priority number. In at least one example, a user can see in the user interface which groups of turnarounds defined within matches overlap. In at least one example, a user can modify priority numbers for such turnarounds. In at least one example, a user is informed if the newly created set overlaps any of existing set. Then the user is prompted to set priority numbers among all affected matches. In at least one example, a user is informed if the match does not affect any turnarounds (such as may happen if the turnarounds set is a subset of a one from a match higher in priority). In at least one example, a user can select artificial intelligence support for creating matches. The control unit 102 analyses defined sets and finds optimal turnaround task lists for them. A user can accept or reject a suggestion. In at least one example, the control unit 102 displays statistical characteristics of the set that backs up the choice. In at least one example, artificial intelligence may suggest a new set of turnarounds for a match.

In at least one example, the control unit has a predefined set of features defining a turnaround set (such as origin, destination, aircraft type, locations within an airport, and/or the like). In at least one example, a set of characteristics can be changed by an administrator. Based on historical data, the control unit 102 can determine a multiple-choice list of the available values for each feature. In at least one example, a user can manually add a new value to the multiple-choice list.

In at least one example, when a turnaround group for a match is defined, the control unit 102 can automatically validate chosen values and may modify available choices for remaining features. For example, if connection type is chosen to be domestic, and operation type is chosen to be arrival, a list of available origins can be modified to contain only airports in the same country.

The systems and methods described herein increase efficiency via accurate turnaround planning, reducing time aircraft spend on the ground, and reducing flight delays. The control unit 102 is configured to determine and select an optimal turnaround task list 136 for an aircraft 108, thereby leading to on-time departure and arrival.

It has been found that the systems and methods described herein can open more connections, as such systems and methods substantially reduce turnaround times. Further, reduced time on the ground leads to increased aircraft utilization and profitability. Further, the systems and methods reduce staff workload and paperwork.

In at least one example, the systems and methods described herein improve turnaround planning, such as by providing easy access, manipulation, and assignation of templates, together with machine learning modeled optimization.

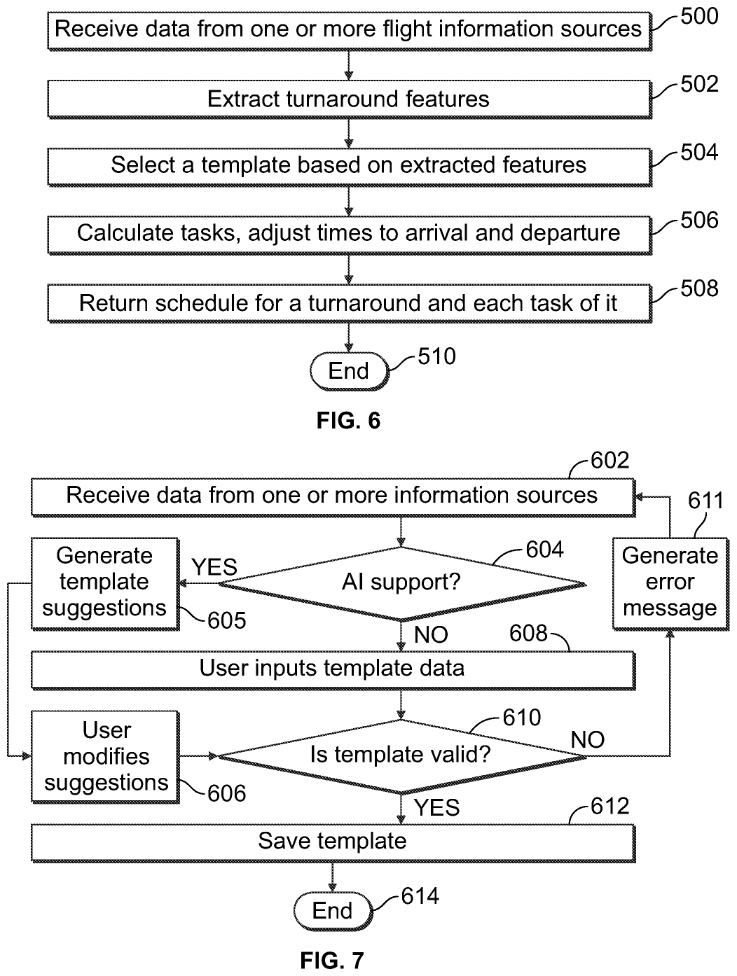

FIG. 6 illustrates a flow chart of a method, according to an example of the present disclosure. Referring to FIGS. 1 and -6, at 500, the control unit 102 receives data from one or more of the flight information sources 104. At 502, the control unit 102 extracts turnaround features from the data. At 504 the control unit 102 selects a turnaround task list 136 (for example, a template) from the plurality of turnaround task lists 136 (for example, a plurality of templates) based on the data received from the flight information sources 104. For example, the control unit 102 compares one or more parameters of the data with one or more parameters of the turnaround task lists 136 to determine a matching score (for example, highest percentage match). In another example, the control unit 102 compares extracted features with matches stored in the database. The control unit 102 selects the particular turnaround task list 136 based on the highest matching score. At 506 the control unit 102 calculates times for tasks to fit arrival and departure schedules. At 508, the control unit 102 returns the schedule for the turnaround with calculated and adjusted times. For example, the control unit 102 returns the schedule to an external airline control system. In another example, the control unit 102 returns the schedule by displaying it on a user interface integrated with the control unit 102.

FIG. 7 illustrates a flow chart of a method, according to an example of the present disclosure. Referring to FIGS. 1 and 7, at 602, the control unit 102 receives data from one or more of the flight information sources 104. At 604, the control unit 102 may or may not use integrated artificial intelligence (AI) support. If AI support is selected, at 605, the AI suggests an optimal turnaround task list (for example, a template) based on data received at 602. At 606, a user can accept or modify the suggestions. If AI support is not selected, at 608, the user inputs data about a turnaround task list. At 610, the control unit 102 verifies the turnaround task list created. If the turnaround task list is valid, at 612, the template is saved in the database 138. Otherwise, at 611, an error message is created and the process returns to 602. In at least one example the control unit 102 can suggest modifications that make the turnaround task list valid. In another example user can manually modify the turnaround task list and validate it again.

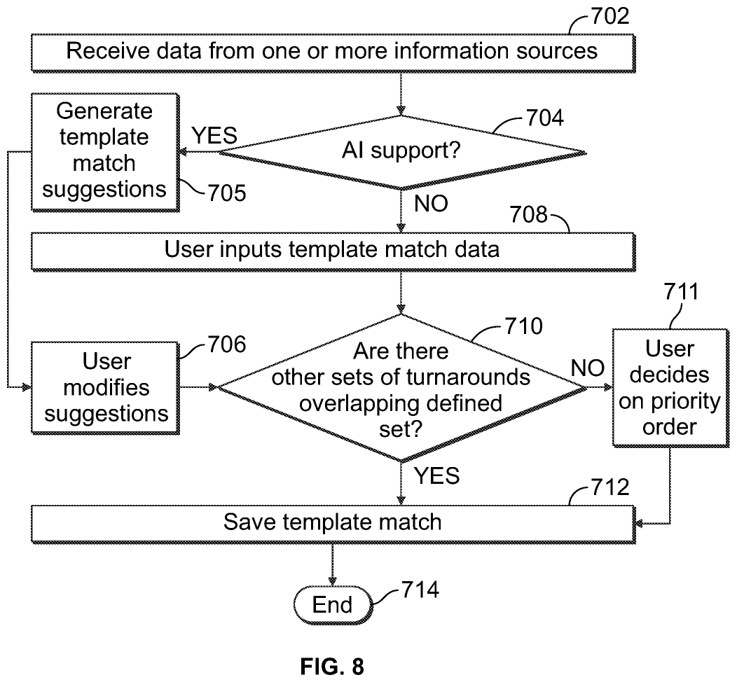

FIG. 8 illustrates a flow chart of a method, according to an example of the present disclosure. Referring to FIGS. 1 and 8, at 702, the control unit 102 receives data from one or more of the flight information sources 104. At 704, the control unit 102 may or may not use integrated AI support. If AI support is selected, at 705 the AI suggests an optimal match based on data received at 702. At 706, a user can accept or modify the suggestions. If AI support is not selected, at 708, user inputs data about a match. At 710, the control unit 102 checks if the turnaround set defined within the match overlaps other sets already stored in the database 138. If there is no overlap, the match is saved in the database 138 at 712. Otherwise, at 711, the user is prompted to specify priorities. When done, the template match is saved at 712.

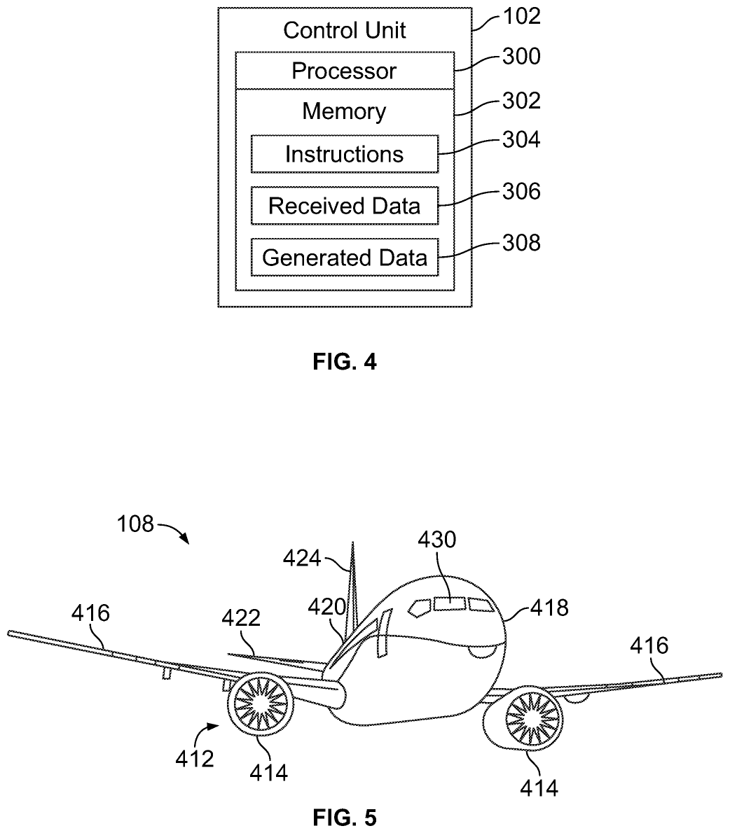

FIG. 4 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 4 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-8, examples of the subject disclosure provide systems and methods that allow large amounts of data to be quickly and efficiently analyzed by a computing device. For example, the control unit 102 can receive and analyze data from hundreds, thousands, or more flight information sources 104 over days, weeks, months, or years. As such, large amounts of data, which may not be readily discernable by human beings, are being tracked and analyzed. The vast amounts of data are efficiently organized and/or analyzed by the control unit 102, as described herein. The control unit 102 analyzes the data in a relatively short time in order to quickly and efficiently determine turnaround task lists 136, and select a turnaround task list 136 for the aircraft 108. As such, examples of the present disclosure provide increased and efficient functionality, and vastly superior performance in relation to a human being reviewing the vast amounts of data.

In at least one example, components of the system 100, such as the control unit 102, provide and/or enable a computer system to operate as a special computer system for determining and selecting turnaround task lists 136 for the aircraft 108. The control unit 102 improves upon standard computing devices by determining such information and automatically communicating with individuals (such as operators of aircraft, ground support crew, flight attendants, and the like) in an efficient and effective manner.

In at least one example, the control unit 102 uses machine learning algorithms which automatically consider factors that influence turnarounds, and based on historical flight data, calculates accurate times for future turnarounds, thereby allowing for in-advance turnaround time optimization. In at least one example, all or part of the systems and methods described herein are or otherwise include an artificial intelligence (AI) or machine-learning system that can automatically perform the operations of the methods also described herein. In at least one example, the control unit 102 can be or otherwise include a deterministic or rules-based evaluation system. In at least one example, the control unit 102 can be an artificial intelligence or machine learning system. These types of systems may be trained from outside information and/or self-trained to repeatedly improve the accuracy with how data is analyzed to determine and present the relevant information to users. For example, an AI control unit 102 can be trained to learn aspects and parameters, efficient changes in operational aspects, and the like, such as based on data received from flight information sources 104, tail-specific capabilities of aircraft, preferences, and habits of flight crew and/or ground crew, and/or the like. Over time, these systems can improve by determining and communicating with increasing accuracy and speed, thereby significantly reducing the likelihood of any potential errors. For example, the AI or machine-learning systems can learn and determine models, associate such models with received data, and determine potential conflicts. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determinations and communications described herein. The training minimizes conflicts and interference by performing an iterative training algorithm, in which the systems are retrained with an updated set of data, and based on the feedback examined prior to the most recent training of the systems. This provides a robust analysis model that can better determine and present turnaround task lists 136.

FIG. 5 illustrates a perspective front view of an aircraft 108, according to an example of the present disclosure. The aircraft 108 includes a propulsion system 412 that includes engines 414, for example. Optionally, the propulsion system 412 may include more engines 414 than shown. The engines 414 are carried by wings 416 of the aircraft 108. In other examples, the engines 414 may be carried by a fuselage 418 and/or an empennage 420. The empennage 420 may also support horizontal stabilizers 422 and a vertical stabilizer 424. The fuselage 418 of the aircraft 108 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 108. It is to be understood that the aircraft 108 can be sized, shaped, and configured differently than shown in FIG. 5.

Further, the disclosure comprises examples according to the following clauses:

Clause 1. A system comprising:
a control unit configured to provide a plurality of turnaround task lists, wherein each of the plurality of turnaround task lists differs from one another,
wherein an aircraft is configured to be operated during a turnaround at an airport according to a selected one of the plurality of turnaround task lists.

Clause 2. The system of Clause 1, wherein each of the plurality of turnaround task lists differs from one another in relation to one or more tasks, times for the tasks, a sequence of tasks, or a number of tasks.

Clause 3. The system of Clauses 1 or 2, wherein the control unit is further configured to receive data from one or more flight information sources.

Clause 4. The system of Clause 3, wherein the control unit is further configured to automatically determine the plurality of turnaround task lists based on the data received from the one or more flight information sources.

Clause 5. The system of Clauses 3 or 4, wherein the control unit is further configured to automatically select the selected one of the plurality of turnaround task lists based on the data received from the one or more flight information sources.

Clause 6. The system of any of Clauses 3-5, wherein the one or more flight information sources comprise one or more of:
a tracking sub-system configured to track the aircraft and other aircraft on ground and in an airspace;
a weather sub-system;
aviation data sources configured to provide information regarding aviation flight operations;
aircraft data sources configured to provide information about various aircraft;
airport data sources configured to provide information regarding one or more airports;
assignment data sources configured to provide information regarding assignments of gate, aircraft, and teams to turnaround;
weight and balance data sources to provide information regarding passengers, baggage, fuel and/or the like; or
flight schedule data sources configured to provide information regarding flight schedules.

Clause 7. The system of any of Clauses 1-6, wherein the control unit is further configured to monitor, during the turnaround, tasks of the selected one of the plurality of turnaround task lists.

Clause 8. The system of Clause 7, wherein the control unit is further configured to update the selected one of the plurality of turnaround task lists in response to a change in one or more aspects of the tasks during the turnaround.

Clause 9. The system of any of Clauses 1-8, further comprising one or more user interfaces in communication with the control unit, wherein the one or more user interfaces comprise a display, and wherein the control unit is further configured to show the selected one of the plurality of turnaround task lists on the display.

Clause 10. The system of any of Clauses 1-9, wherein the control unit is further configured to automatically operate one or more devices to automatically perform one or more tasks within the selected one of the plurality of turnaround task lists.

Clause 11. The system of any of Clauses 1-10, wherein one or more controls of the aircraft are configured to be automatically operated to perform one or more tasks within the selected one of the plurality of turnaround task lists.

Clause 12. The system of any of Clauses 1-11, wherein the control unit is an artificial intelligence or machine learning system.

Clause 13. A method comprising:
providing, by a control unit, a plurality of turnaround task lists, wherein each of the plurality of turnaround task lists differs from one another in relation to one or more tasks, times for the tasks, a sequence of tasks, or a number of tasks,
wherein an aircraft is operated during a turnaround at an airport according to a selected one of the plurality of turnaround task lists.

Clause 14. The method of Clause 13, further comprising receiving, by the control unit, data from one or more flight information sources.

Clause 15. The method of Clause 14, further comprising automatically selecting, by the control unit, the selected one of the plurality of turnaround task lists based on the data received from the one or more flight information sources.

Clause 16. The method of any of Clauses 13-15, further comprising monitor, by the control unit, during the turnaround, tasks of the selected one of the plurality of turnaround task lists.

Clause 17. The method of Clause 16, further comprising updating, by the control unit, the selected one of the plurality of turnaround task lists in response to a change in one or more aspects of the tasks during the turnaround.

Clause 18. The method of any of Clauses 13-17, further comprising automatically operating one or more devices to automatically perform one or more tasks within the selected one of the plurality of turnaround task lists.

Clause 19. The method of any of Clauses 13-18, further comprising automatically operating or more controls of the aircraft to perform one or more tasks within the selected one of the plurality of turnaround task lists.

Clause 20. A non-transitory computer-readable storage medium comprising executable instructions that, in response to execution, cause one or more control units comprising a processor, to perform operations comprising:
providing a plurality of turnaround task lists, wherein each of the plurality of turnaround task lists differs from one another in relation to one or more tasks, times for the tasks, a sequence of tasks, or a number of tasks,
wherein an aircraft is operated during a turnaround at an airport according to a selected one of the plurality of turnaround task lists.

Clause 21, the systems, methods, or the like of any of the preceding Clauses, wherein the control unit is further configured to automatically match one of the plurality of turnaround task lists to a set of turnaround features.

As described herein, examples of the present disclosure provide improved systems and methods for managing a turnaround of an aircraft at an airport. Further, examples of the present disclosure provide effective and efficient systems and methods for managing turnaround.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to provide a plurality of turnaround task lists, wherein each of the plurality of turnaround task lists differs from one another,
wherein an aircraft is configured to be operated during a turnaround at an airport according to a selected one of the plurality of turnaround task lists.

2. The system of claim 1, wherein each of the plurality of turnaround task lists differs from one another in relation to one or more tasks, times for the tasks, a sequence of tasks, parameter of the tasks, or a number of tasks.

3. The system of claim 1, wherein the control unit is further configured to receive data from one or more flight information sources.

4. The system of claim 3, wherein the control unit is further configured to automatically determine the plurality of turnaround task lists based on the data received from the one or more flight information sources.

5. The system of claim 4, wherein the control unit is further configured to automatically match one of the plurality of turnaround task lists with a set of turnaround features.

6. The system of claim 3, wherein the control unit is further configured to automatically select the selected one of the plurality of turnaround task lists based on the data received from the one or more flight information sources.

7. The system of claim 3, wherein the one or more flight information sources comprise one or more of:
a tracking sub-system configured to track the aircraft and other aircraft on ground and in an airspace;
a weather sub-system;
aviation data sources configured to provide information regarding aviation flight operations;
aircraft data sources configured to provide information about various aircraft;
airport data sources configured to provide information regarding one or more airports;
flight schedule data sources configured to provide information regarding flight schedules;
weight and balance data sources to provide information regarding passengers, baggage, fuel and/or the like; or
assignment data sources configured to provide information regarding assigned resources.

8. The system of claim 1, wherein the control unit is further configured to automatically select the selected one of the plurality of turnaround task lists based on data received from one or more flight information sources.

9. The system of claim 1, wherein the control unit is further configured to monitor, during the turnaround, tasks of the selected one of the plurality of turnaround task lists.

10. The system of claim 9, wherein the control unit is further configured to update the selected one of the plurality of turnaround task lists in response to a change in one or more aspects of the tasks during the turnaround.

11. The system of claim 1, further comprising one or more user interfaces in communication with the control unit, wherein the one or more user interfaces comprise a display, and wherein the control unit is further configured to show the selected one of the plurality of turnaround task lists on the display.

12. The system of claim 1, wherein the control unit is further configured to automatically operate one or more devices to automatically perform one or more tasks within the selected one of the plurality of turnaround task lists.

13. The system of claim 1, wherein one or more controls of the aircraft are configured to be automatically operated to perform one or more tasks within the selected one of the plurality of turnaround task lists.

14. The system of claim 1, wherein the control unit is an artificial intelligence or machine learning system.

15. A method comprising:
providing, by a control unit, a plurality of turnaround task lists, wherein each of the plurality of turnaround task lists differs from one another in relation to one or more tasks, times for the tasks, a sequence of tasks, parameters of the tasks, or a number of tasks,
wherein an aircraft is operated during a turnaround at an airport according to a selected one of the plurality of turnaround task lists.

16. The method of claim 15, further comprising receiving, by the control unit, data from one or more flight information sources.

17. The method of claim 15, further comprising automatically selecting, by the control unit, the selected one of the plurality of turnaround task lists based on the data received from the one or more flight information sources.

18. The method of claim 15, further comprising monitor, by the control unit, during the turnaround, tasks of the selected one of the plurality of turnaround task lists.

19. The method of claim 18, further comprising updating, by the control unit, the selected one of the plurality of turnaround task lists in response to a change in one or more aspects of the tasks during the turnaround.

20. The method of claim 15, further comprising automatically operating one or more devices to automatically perform one or more tasks within the selected one of the plurality of turnaround task lists.

21. The method of claim 15, further comprising automatically operating or more controls of the aircraft to perform one or more tasks within the selected one of the plurality of turnaround task lists.

22. The method of claim 15, further comprising automatically matching one of the plurality of turnaround task lists to a set of turnaround features.

23. The method of claim 15, further comprising automatically selecting, by the control unit, the selected one of the plurality of turnaround task lists based on data received from the one or more flight information sources.

24. A non-transitory computer-readable storage medium comprising executable instructions that, in response to execution, cause one or more control units comprising a processor, to perform operations comprising:
providing a plurality of turnaround task lists, wherein each of the plurality of turnaround task lists differs from one another in relation to one or more tasks, times for the tasks, a sequence of tasks, parameters of the tasks, or a number of tasks,
wherein an aircraft is configured to be operated during a turnaround at an airport according to a selected one of the plurality of turnaround task lists.
